(19) United States
(12) Patent Application Publication
(10) Pub. No.: US 2009/0166240 A1
(43) Pub. Date: Jul. 2, 2009

(54) CONTAINER WITH GRIPPABLE BODY AND LID

(76) Inventors: Leonard S. Scarola, Basking Ridge, NJ (US); Linda Carol Roman, Palatin, IL (US)

Correspondence Address: STITES & HARBISON PLLC, 1199 NORTH FAIRFAX STREET, SUITE 900, ALEXANDRIA, VA, 22314, US

(21) Appl. No.: 11/964,221

(22) Filed: Dec. 26, 2007

(51) Int. Cl. B65D 83/38; B65D 41/04; B29C 45/14

(52) U.S. Cl. 206/524.2; 220/288; 264/259

(57) ABSTRACT

A container comprises a container body and a lid. The lid has a top and a skirt and an outer layer of material softer than the skirt is adhered to the outer surface of the skirt. The outer layer may have a thickness of at least 20 mils and may be molecularly bonded to the skirt. Advantageously, the outer layer covers substantially the entire surface of the skirt. The lid may be formed using a two-shot injection molding process in which the lid is formed in a first step and the outer layer of a softer material is formed on the skirt of the lid during the second step of the two-shot injection molding process. In addition, the container body includes one or more grippable surfaces as areas of relatively higher coefficients of friction.

### FIELD OF THE INVENTION

The present invention relates to a container with an improved grippable surface, and in particular, a container comprising a container body and lid, each of which have one or more improved grippable surfaces.

### BACKGROUND OF THE INVENTION

Many containers such as jars have a top opening and a lid or other closure to cover or close over the opening. One typical arrangement includes a threaded jar neck opening onto which a correspondingly threaded lid twists on and off. In order to provide a grippable surface, some lids include ribs or grooves along their axially extending portion, commonly known as the skirt of the lid, to provide enhanced grippability and thus allow one to more easily twist the lid on and off the neck of the container.

U.S. Pat. No. 6,481,589 discloses a jar closure in which a rigid piece forms a first part of the lid, including its skirt, and a second part is molded onto the first, rigid part, to define a portion of the periphery of the exterior of the lid. The second part is formed within an inlay or void of the skirt so that the resulting lid has the second part flush with the outer surface of the skirt and/or the top of the first part of the lid.

U.S. Patent Application Publication No. 2005/0145593 discloses a lid with a soft feel gripping surface in which an in-mold label forms a thin gripping surface over the skirt of a lid.

One gains access to the contents of the prior threaded container by applying torque to the lid while applying pressure to the sides of a container body, thereby maintaining the container body stationary as one twists the lid off of the container body. Thus, the torque applied to the lid must be resisted by an appropriate torque applied to the container body. In order to apply a sufficient torque to the container body to resist the torque applied to the lid, typically, a user has to squeeze the container body very hard or force the container body down on a work surface or countertop or use some other technique. All of these methods are awkward and uncomfortable; and squeezing the container body may result in the container being forced inward and may force some of the contents out of the container during opening.

There exists a need in the art for improved container having grippable surfaces which allow one to more easily open and close a container.

### BRIEF SUMMARY OF THE INVENTION

The present invention concerns a container with a grippable lid closure in which the lid has a soft outer layer formed on a skirt portion of a lid to provide a grippable surface. Advantageously, the outer layer forms a strong bond to the skirt which may include an intermolecular bond in which respective materials from the outer layer and the skirt are intermixed with one another. Further, advantageously the outer layer is of a sufficient thickness to provide an enhanced grippable surface which is comfortable for one to grasp and allows one to easily open a container to which the lid is attached. In addition, the container includes a grippable surface on an exterior surface of the body of the container. The grippable surface may comprise a rubbery material applied to the exterior of the container body, an exterior layer intermolecularly bonded to the container body, or a roughened portion of the outer surface of the container body.

The present invention, in one form, concerns a container comprising a container body having an opening and at least a portion of its outer surface comprising a material having a high coefficient of friction. The container further includes a lid having a top and a skirt. The lid has an outer layer of a material softer than the skirt adhered to the outer surface of the skirt. The lid engages with the container body over the opening.

The high coefficient of friction material may be intermolecularly bonded to the container body.

Advantageously, the high coefficient of friction material has a coefficient of friction which is higher than the remaining portion of the container body. The high coefficient of friction material allows one to apply a sufficient force to the container body during opening and closing to resist the torque applied to twist the lid.

The present invention, in another form thereof, comprises a container body and a lid, each composed of a respective first material. The container body and lid each have at least a portion of their respective outer surfaces comprising a respective second material associated with the respective first material. The respective second material is associated with the respective first material to prevent relative movement therebetween. The respective second material provides for applying a higher torque for a given force applied to a remaining portion of the container body and lid, without slipping.

The present invention, in another form thereof, relates to a method of manufacturing a container comprising forming a container body having an opening using a first step of a two step injection molding process and forming a portion of an outer layer of the container body using a second step of the two step injection molding process to intermolecularly bond the outer layer to the container body.

These and other objects of the present invention will become apparent from the brief description of the drawings which follow, together with the detailed description of the preferred embodiments.

### BRIEF DESCRIPTION OF THE DRAWINGS

There follows a detailed description of the preferred embodiments of the present invention, to be read together with the accompanying drawings, wherein:

FIG. 1 is a perspective view of a closure in accordance with the present invention.

FIG. 2 is a cross sectional view of the closure taken along line 2-2 of FIG. 1.

FIG. 3 is an enlarged partial view of the closure from box 15 from FIG. 2.

FIG. 4 is an elevational view of a container comprising a container body and lid in accordance with the present invention.

FIG. 5 is a plan view of the container of FIG. 4, viewed from below.

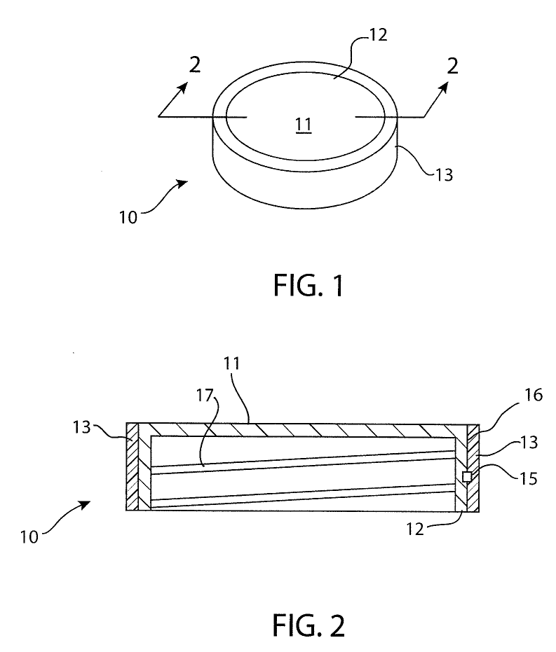

### DETAILED DESCRIPTION OF THE PREFERRED EMBODIMENTS

Referring to the drawings, like elements are represented by like numbers throughout the several views.

Container 14 comprises container body 19 and lid 10. Lid 10 has a top 11 and a skirt 12. Advantageously, the lid 10 is formed of a plastic material or polymer using injection molding in a first step of a two-shot molding process. The lid 10 can be composed of polyethylene or polypropylene. Alternatively, the lid 10 can be formed of any other suitable material known to one of ordinary skill in the art.

The lid 10 includes an outer layer 13 which is adhered to the skirt 12, preferably covering substantially the entire surface of skirt 12. The outer layer 13 is associated with skirt 12 so that the outer layer 13 does not slip or move relative to the skirt 12 when twisted to open or close a container 14 (FIG. 4).

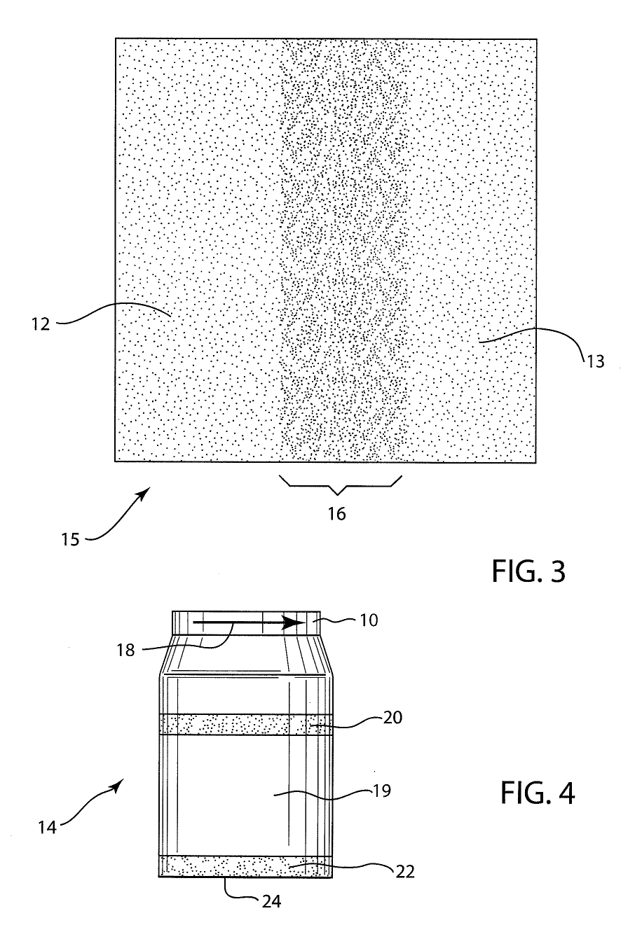

In one advantageous method of making the lid 10, the outer layer 13 is formed during the second step of a two-shot molding process. Preferably, the resulting skirt 13 is intermolecularly bonded to the skirt 12 such that interface 16 formed therebetween includes material from the skirt 12 and outer layer 13 intermixed with one another, as shown in FIG. 3 which is an enlargement of box 15 of FIG. 2. Although it is advantageous to have intermolecular bonding between skirt 12 and outer layer 13, it is not necessary to have intermolecular bonding to achieve non-relative movement between the skirt and the outer layer.

The outer layer 13 is at least 20 mils thick, preferably at least 38 mils and more preferably 40-60 mils. These thicknesses provide a comfortable grippable surface along the skirt 12 of the lid 10 to allow one to easily grip and open the container 14. The outer layer 13 can be formed of any suitable soft material which includes rubberized elastomer.

Although the preferred method of forming closure 10 is two-shot injection molding, alternatively any other manufacturing process known to one of ordinary skill in the art can be used which forms a skirt 12 with a sufficiently strong bonded or adhered softer outer layer.

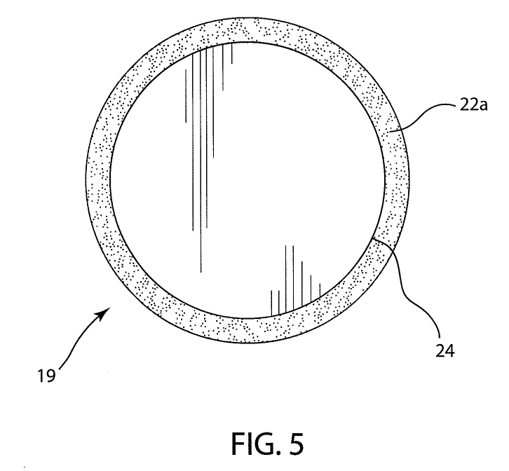

The exterior surface of container body 19 includes a grippable surface 20, which encircles container body 19 around its midsection, and/or a grippable surface 22, which is formed at the base of the container body 19. The grippable surface 22 extends onto the bottom 24 of the container body (FIG. 5). The grippable surfaces 20, 22 have a high coefficient of friction relative to the remaining portion of the exterior surface of the container body 19. As a result, a user can firmly grasp container body 19 by holding one of the grippable surfaces as one removes or twists the lid 10. Alternatively, one can apply pressure and force the surface 22a of container body 19 down on a countertop or other surface, while one removes or twists the lid 10. Although FIG. 5 depicts grippable surface 22a as only covering a perimeter of the bottom 24 of container body 19, the grippable surface 22a may cover the entire bottom 24.

The grippable surfaces 20, 22 may be made of a softer material than that of the remaining portion of the container body 19 and may be intermolecularly bonded to its surface. For example, the grippable surfaces 20, 22 can be formed using a two-shot molding process like the one which can be used to form the outer layer 13 on lid 10. Alternatively, the grippable surfaces 20, 22 may be composed of a rubberized material which is applied over the surface of the container body 19. The grippable surfaces also may be formed by applying a texture to the exterior surface of the container body 19. The texture may be applied during injection molding of a container body 19 or the container body 19 may be roughened following the injection molding process. Advantageously, the grippable surfaces 20, 22 allow one to apply more torque to the container without applying an inward force to compress the container body 19.

In one alternative form, the grippable surfaces, such as grippable surface 20 may be composed of an adhesive label applied to the container body 19, in which the label has a textured surface. Optionally, an ink layer may be formed over the textured surface of the label.

In one application or use, lid 10 has threads 17 on the interior surface of skirt 12 which allows lid 10 to be removed from container body 19 which has complementary threads (not shown), by twisting or rotating lid 10 in a counterclockwise direction as indicated by arrow 18 of FIG. 4.

It will now be apparent to one of ordinary skill in the art that the present lid offers advantages and features not found in prior containers. For example the present lid includes a sufficiently thick outer layer of a soft material which provides a comfortable and grippable surface. An additional advantageous feature of the present lid is an outer layer sufficiently bonded to a skirt such as by being intermolecularly bonded thereto, thereby ensuring that the outer layer will not slip relative to the skirt when opening or closing a container. The presence of a high coefficient of friction of the grippable surfaces on the container body allows a user to firmly hold the container body stationary relative to the lid to resist the torque applied to the container body when twisting the lid on and off the container body. As a result, the present container is easier to open and close than prior containers.

Although the invention has been described above in relation to preferred embodiments thereof, it will be understood by those skilled in the art that variations and modifications can be effected in these preferred embodiments without departing from the scope and spirit of the invention.

We claim:

1. A container comprising:
a container body having at least a portion of its outer surface comprising a material having a high coefficient of friction, and an opening; and
a lid having a top and a skirt, said skirt having an outer layer formed thereon of a material softer than the skirt and associated with the outer surface of the skirt to prevent relative movement therebetween, said lid engaged with the container body over the opening.

2. The container of claim 1, wherein the lid is threadedly engaged with the container body.

3. The container of claim 1, wherein the outer layer has a thickness of at least 20 mils.

4. The container of claim 1, wherein the high coefficient of friction material has a coefficient of friction which is higher than that of the remaining portion of the container body.

5. The container of claim 1, wherein the container body comprises at least two portions of its outer surface which comprises a high coefficient of friction material.

6. The container of claim 1, wherein the at least one portion of the outer surface comprising a material having a high coefficient of friction is in the form of a band which encircles the container body.

7. The container of claim 1, wherein the at least one portion of the outer surface comprising a material having a high coefficient of friction is disposed at the base of the container body, opposite the opening.

8. The container of claim 1, wherein the high coefficient of friction material is intermolecularly bonded to the remaining portion of the container body.

9. The container of claim 1, wherein the high coefficient of friction material comprises a textured surface of the container body.

10. The container of claim 1, wherein the high coefficient of friction material comprises a rubbery material applied to the surface of the container body.

11. The container of claim 1, wherein the at least one portion of the outer surface comprising a material having a high coefficient of friction is disposed at a bottom surface of the container body, opposite the opening.

12. A container comprising:
a container body and a lid, each composed of a respective first material, the container body and lid having at least a portion of its respective outer surface comprising a respective second material associated with the respective first material, the respective second material associated with the respective first material so as to prevent relative movement therebetween, the respective second material providing for applying a higher torque for a given force than the torque provided by the same force when applied to a remaining portion of the container body and lid.

13. The container of claim 12, wherein each respective second material has a higher coefficient of friction that the respective first material.

14. The container of claim 12, wherein at least one of the respective second materials of the container body and the lid is intermolecularly bonded to the respective first material.

15. The container of claim 12, wherein at least one of the respective second materials of the container body and the lid comprises a textured surface.

16. The container of claim 12, wherein at least one of the respective second materials of the container body and the lid comprises a rubbery material applied to the surface of the container body.

17. A method of manufacturing a container, said method comprising:
forming a container body having an opening using a first step of a two step injection molding process; and
forming a portion of an outer layer of material on the container body using a second step of the two-shot injection molding process to intermolecularly bond the outer layer to the container body.

18. The method of claim 17, wherein the portion of the outer layer of material formed on the container body has a high coefficient of friction.

19. The method of claim 17, wherein the portion of the outer layer of material formed on the container body has a higher coefficient of friction than the container body.

20. The method of claim 17, further comprising:
forming a lid having a skirt using a first step of a two-shot injection molding process; and
forming an outer layer of a material softer than the skirt on the skirt using a second step of the two-shot injection molding process to intermolecularly bond the outer layer to the skirt.
